(19) United States
(12) Patent Application Publication
(10) Pub. No.: US 2015/0006119 A1
(43) Pub. Date: Jan. 1, 2015

(54) INSOLE DESIGN SYSTEM

(71) Applicant: DREAM GP INC., Osaka-shi, Osaka (JP)

(72) Inventors: Motohide Arayama, Osaka-shi (JP); Shinkichi Oshiki, Osaka-shi (JP)

(73) Assignee: Dream GP Inc., Osaka-shi Osaka (JP)

(21) Appl. No.: 14/378,239

(22) PCT Filed: Sep. 6, 2013
(86) PCT No.: PCT/JP2013/074092

§ 371 Date: Aug. 12, 2014

(30) Foreign Application Priority Data
Sep. 11, 2012 (JP) 2012-199557

(51) Int. Cl. A43D 1/02; G06F 17/50; A43B 13/38

(52) U.S. Cl. CPC A43D 1/02; A43B 13/38; G06F 17/50
USPC 703/1

(57) ABSTRACT

Provided is an insole design system that can determine design parameters in accordance with set rules and can explain the design parameters in an easy-to-understand manner.

The present invention is provided with a foot dimensions input unit (52) that receives input of the dimensions of the outer shape of a foot; a design parameter input unit (54) that, with respect to the shape of a specific portion of the surface of an insole, receives the input of design parameters determined with the position of a foot bone as a baseline; a bone position estimation unit (56) that, from the dimensions received by the foot dimensions input unit (52), estimates the position of the bone that is the baseline of the design parameters; and a data calculation unit (58) that calculates data for fabricating the shape of the surface of the insole from the design parameters received by the design parameter input unit (54) and the position of the bone estimated by the bone position estimation unit (56).

### TECHNICAL FIELD

The present invention relates to an insole design system and, in particular, to an insole design system for designing and fabricating individually an insole to be placed in a shoe.

### BACKGROUND ART

Various kinds of insoles have been proposed that have a shape and a structure corresponding to the arch structure of the skeleton of the foot. Further, a technique has been proposed that an insole having an optimal shape with respect to an individual difference or an application is fabricated with measuring the three-dimensional shape of the foot (for example, see Patent Document 1).

### CITATION LIST

### Patent Literature

Patent Document 1: Japanese Laid-Open Patent Publication No. 2009-45244

### SUMMARY OF THE INVENTION

### Problem to be Solved by the Invention

A custom-made insole is fabricated in a shape in which depressions and protrusions are added in appropriate portions in accordance with the shape of the foot obtained by molding or measurement. If the positions and the dimensions of the depressions and protrusions to be added in accordance with the shape of the foot were determined by experience or intuition of a designer, a different insole would be fabricated depending on the designer. This situation is not preferable.

For the purpose of obtaining a fixed quality, it is desired that design parameters can be determined in accordance with a fixed rule. Further, it is desired that the design parameters can be explained in an easy-to-understand manner to a person who places an order for the insole, like what kind of effect has been aimed in the design of the insole and how the effect is reflected in the design parameters. Further, it is desired that the fabrication history of the insole can easily be utilized, for example, in a case that an insole used in another shoe is to be fabricated on the basis of design data of an insole fabricated in the past or, alternatively, in a case that an insole is to be refabricated with observing a change in the shape of the foot or in the motion of the foot at the time of walking caused by the use of the insole.

The present invention has been devised in view of such situations. An object thereof is to provide an insole design system in which design parameters can be determined in accordance with a fixed rule, the design parameters can be explained in an easy-to-understand manner, and the fabrication history of the insole can easily be utilized.

### Means for Solving the Problem

In order to resolve the above-mentioned problem, the present invention provides an insole design system having the following configuration.

An insole design system comprises: (a) a foot dimensions input unit for receiving input of dimensions of an outer shape of a foot; (b) a design parameter input unit for receiving input of design parameters concerning a shape of a specific portion of a surface of an insole and determined with reference to a position of a bone of the foot; (c) a bone position estimation unit for estimating the position of the bone serving as a reference of the design parameters, from the dimensions received by the foot dimensions input unit; and (d) a data calculation unit for, from the position of the bone estimated by the bone position estimation unit and the design parameters received by the design parameter input unit, calculating data used for forming the shape of the surface of the insole.

In the above-mentioned configuration, when the dimensions of the outer shape of the foot and the design parameters are inputted, the insole design system calculates data used for forming the surface shape of the insole.

According to the above-mentioned configuration, the design parameters are determined with reference to the position of the bone of the foot. Thus, the design parameters for the insole can be determined in accordance with a fixed rule in which the position of the bone of the foot is taken into consideration. Further, the design parameters can be explained in an easy-to-understand manner. Furthermore, as the fabrication history of the insole, design parameters defined with reference to the position of the bone of the foot are accumulated so that the fabrication history of the insole can easily be utilized.

Preferably, the specific portion includes an inner arch corresponding to an inner side longitudinal arch of the foot. The design parameters include a peak height, a peak position, and an arch length of the inner arch. The peak position of the inner arch is determined with reference to any one of a medial cuneiform bone, a navicular bone, and a sustentaculum tali of the heel. In the arch length of the inner arch, one end of the inner arch is determined with reference to a position of the heel and the other end of the inner arch is determined with reference to a position of the first metatarsal bone. The bone position estimation unit estimates the positions of the medial cuneiform bone, the navicular bone, the heel and the sustentaculum tali thereof, and the first metatarsal bone, from the dimensions received by the foot dimensions input unit.

In this case, the inner arch corresponding to the inner side longitudinal arch of the foot can be designed easily and efficiently with reference to the bone whose position has been estimated from the dimensions of the outer shape of the foot.

Preferably, the specific portion includes an outer arch corresponding to an outer side longitudinal arch of the foot. The design parameters include a peak height, a peak position, and an arch length of the outer arch. The peak position of the outer arch is determined with reference to the position of the cuboid bone. In the arch length of the outer arch, one end of the outer arch is determined with reference to a position of the heel and the other end of the outer arch is determined with reference to a position of the fifth metatarsal bone. The bone position estimation unit estimates the positions of the cuboid bone, the heel, and the fifth metatarsal bone from the dimensions received by the foot dimensions input unit.

In this case, the outer arch corresponding to the outer side longitudinal arch of the foot can be designed easily and efficiently with reference to the bone whose position has been estimated from the dimensions of the outer shape of the foot.

### EFFECTS OF THE INVENTION

According to the present invention, design parameters can be determined in accordance with a fixed rule and the design parameters can be explained in an easy-to-understand manner.

### BRIEF DESCRIPTION OF THE DRAWINGS

FIG. 1 is an explanation diagram for the arch structure of the skeleton of a foot.

FIG. 2 is a schematic diagram of an insole.

FIG. 3 is a block diagram showing a configuration of an insole design system.

FIG. 4 is an explanation diagram for the dimensions of the outer shape of a foot.

FIG. 5 is an explanation diagram for the bone of a foot.

FIG. 6 is an explanation diagram for design parameters of an insole.

FIG. 7 is an explanation diagram for design parameters of an insole.

FIG. 8 is an explanation diagram for design parameters of an insole.

FIG. 9 is an explanation diagram for design parameters of an insole.

FIG. 10 is an explanation diagram for design parameters of an insole.

FIG. 11 is an explanation diagram for design parameters of an insole.

FIG. 12 is an explanation diagram for design parameters of an insole.

FIG. 13 is an explanation diagram for design parameters of an insole.

FIG. 14 is an explanation diagram for design parameters of an insole.

FIG. 15 is an explanation diagram for screen display on a terminal.

FIG. 16 is an explanation diagram for screen display on a terminal.

FIG. 17 is an explanation diagram for screen display on a terminal.

FIG. 18 is an explanation diagram for screen display on a terminal.

FIG. 19 is an explanation diagram for screen display on a terminal.

FIG. 20 is an explanation diagram for screen display on a terminal.

### MODE FOR CARRYING OUT THE INVENTION

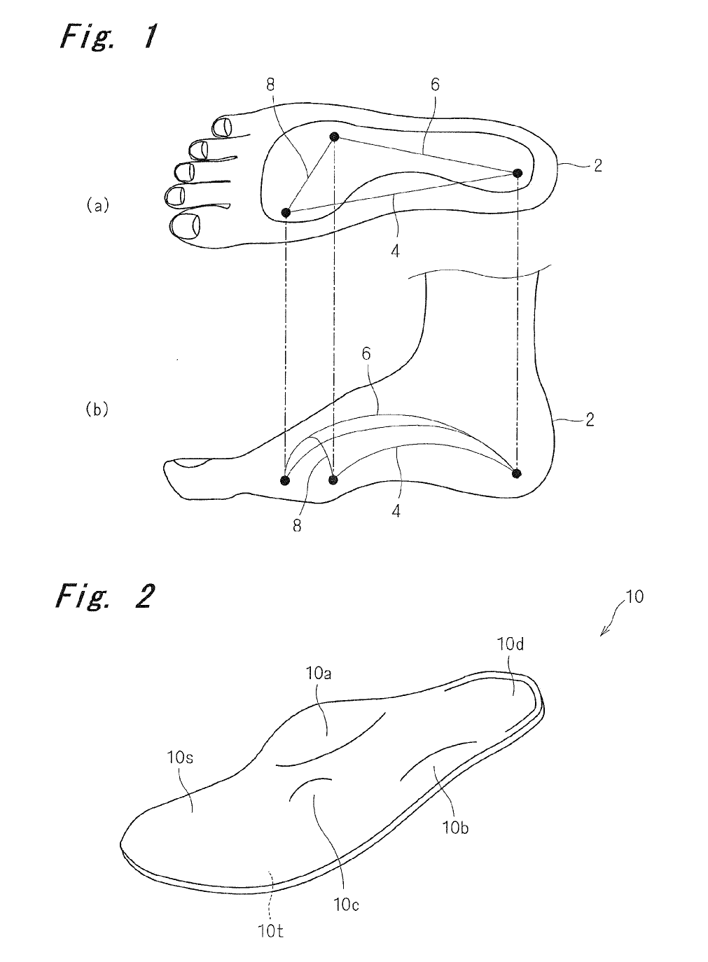

Embodiments of the present invention are described below with reference to FIGS. 1 to 20.

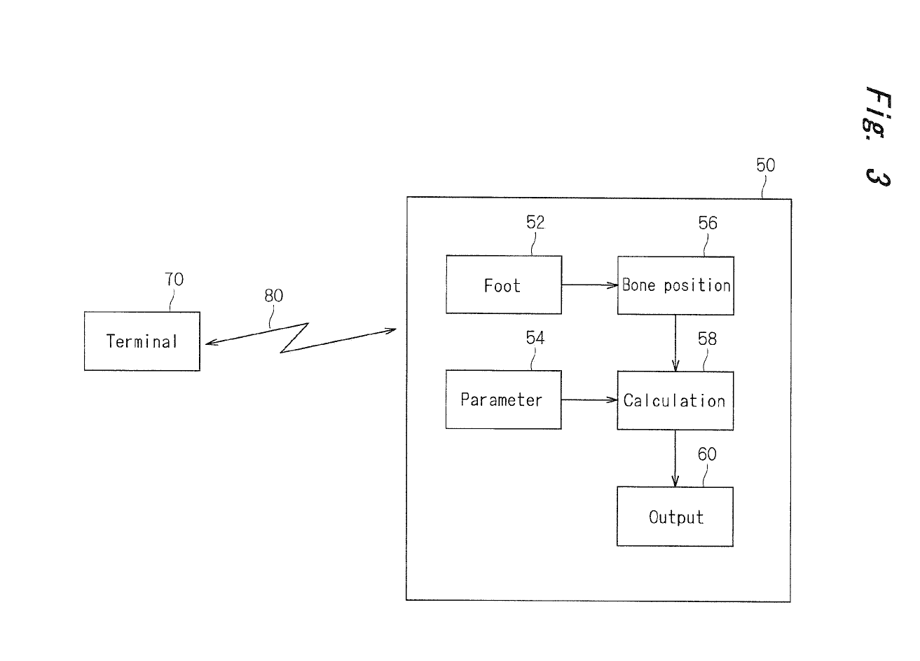

FIG. 1 is an explanation diagram for the arch structure of the skeleton of a foot 2, showing a right foot. FIG. 2 is a schematic diagram showing the shape of the surface 10s of an insole 10, showing one for the left foot. As shown in FIG. 1, in the skeleton of the foot 2, lines 4, 6, and 8 joining the three points of the root of the big toe, the root of the little finger, and the heel are warped in arc shapes. These arches are referred to as an inner side longitudinal arch 4, an outer side longitudinal arch 6, and a transverse arch 8, respectively. In accordance with such an arch structure of the foot, as shown in FIG. 2, protruded portions 10a, 10b, and 10c, a depressed portion 10d, and the like are formed in the surface 10s of the insole 10 so that the body weight can be supported by the entire sole and the shape of the arch structure of the foot can be adjusted.

FIG. 3 is a block diagram showing the configuration of an insole design system 50. As shown in FIG. 3, the insole design system 50 is constructed on a server and connected to a terminal 70 through a communication network 80 such as an LAN and the Internet so as to perform communication with the terminal 70. For example, the terminal 70 may be constructed from: a personal computer provided with a display, a keyboard, a touchpad, a mouse, and the like; a tablet type computer provided with a touch panel; a smart phone (a multifunctional portable phone or PHS); or the like.

Here, a part of the function of the insole design system 50 may be installed as application software in the terminal 70. Further, the insole design system 50 and the terminal 70 may be integrated with each other by direct connection or the like so as to constitute a dedicated device of stand-alone type.

As shown in FIG. 3, the insole design system 50 includes a foot dimensions input unit 52, a design parameter input unit 54, a bone position estimation unit 56, a data calculation unit 58, and an output unit 60.

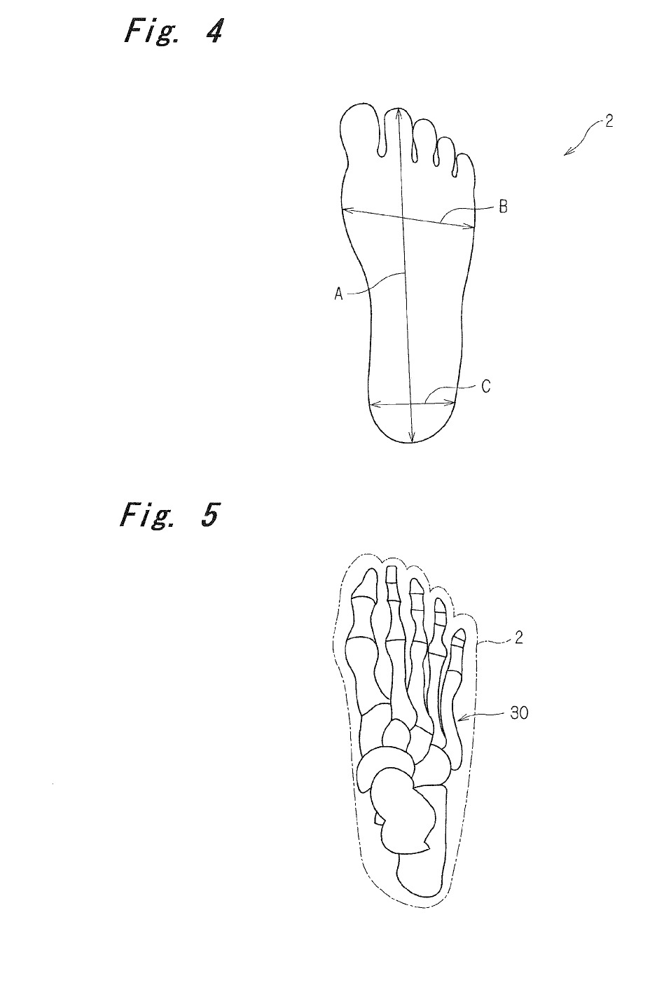

The foot dimensions input unit 52 transmits, to the terminal 70, data used for displaying a screen shown in FIG. 15 onto the terminal 70 and then, when the terminal 70 is operated, receives input concerning the dimensions of the outer shape of the foot. As shown in the explanation diagram of FIG. 4, the dimensions of the outer shape of the foot whose input is received by the foot dimensions input unit 52 include dimensions consisting of the foot length A, the foot width B, and the heel width C. The foot length A, the foot width B, and the heel width C may be defined appropriately. For example, the foot length A is the length of the foot outer shape on a line along the line joining the heel and the second toe in a situation that the reference in contact with the foot is viewed vertically. The foot width B is the length of the outer shape of the foot on the line joining the roots of the first toe and the fifth toe in a situation that the reference in contact with the foot is viewed vertically. The heel width C is the width of the outer shape of the foot at a position of 17% of the foot length from the heel (the dimension on a line perpendicular to the line joining the heel and the second toe) in a situation that the reference in contact with the foot is viewed vertically.

From the dimension data of the outer shape of the foot whose input has been received by the foot dimensions input unit 52, the bone position estimation unit 56 estimates the position of a specific bone (described later in detail) contained in the skeleton 30 in the inside of the foot 2 as shown in FIG. 5.

The bone position estimation unit 56 estimates the position of the bone, for example, by using the data of a standard model in which the dimensions of the outer shape of a foot and the position of the bone are in advance made into correspondence to each other. Specifically, with respect to the foot length, the foot width, and the heel width, ratios are calculated between the data whose input has been received by the foot dimensions input unit 52 and the data of the standard model. Then, on the basis of the ratios, the standard model is expanded or reduced and then the position of the bone in the expanded or reduced standard model is adopted as the estimated position. A plurality of standard models may be prepared in advance and then several standard models may be selected such that the difference from the input data of the foot length, the foot width, and the heel width becomes small. Then, the position of the bone may be estimated by interpolation using the selected standard models. The employed standard model may be different depending on the type of the foot (such as a Greek type, an Egyptian type, and a square type).

Here, the position of the bone of the foot may be estimated by a method other than the above-mentioned one.

However, the position of the bone of the foot serves as the reference at the time of designing the insole and hence need be estimated uniquely.

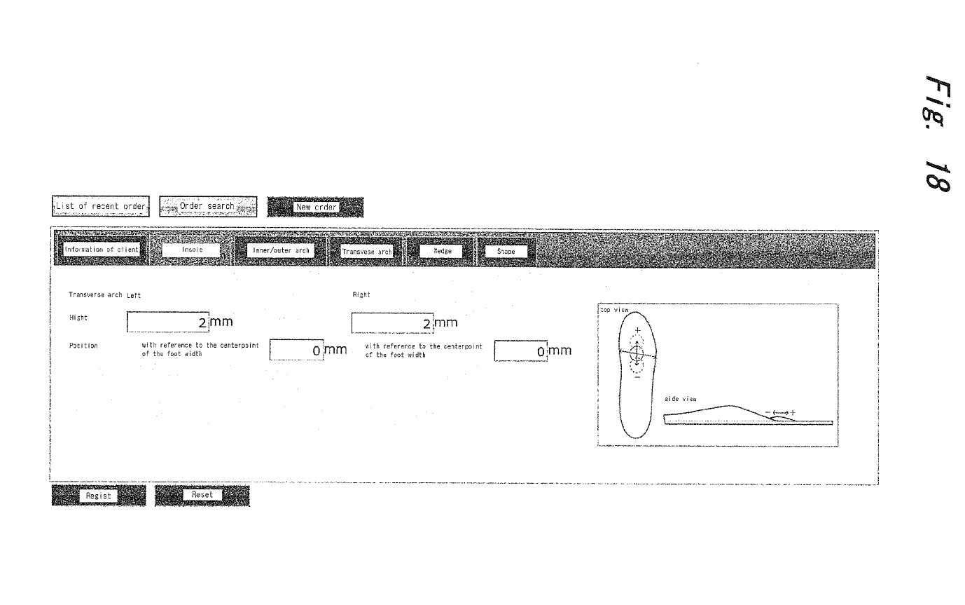

In response to the operation from the terminal 70, the design parameter input unit 54 transmits, to the terminal 70, data used for displaying a screen shown in FIGS. 16 to 20 and then, when the terminal 70 is operated, receives input concerning the design parameters. The design parameter input unit 54 receives input of the following design parameters (a) to (g), from the terminal 70.

### (a) Insole Length, Insole Width, Insole Thickness, and Insole Shape

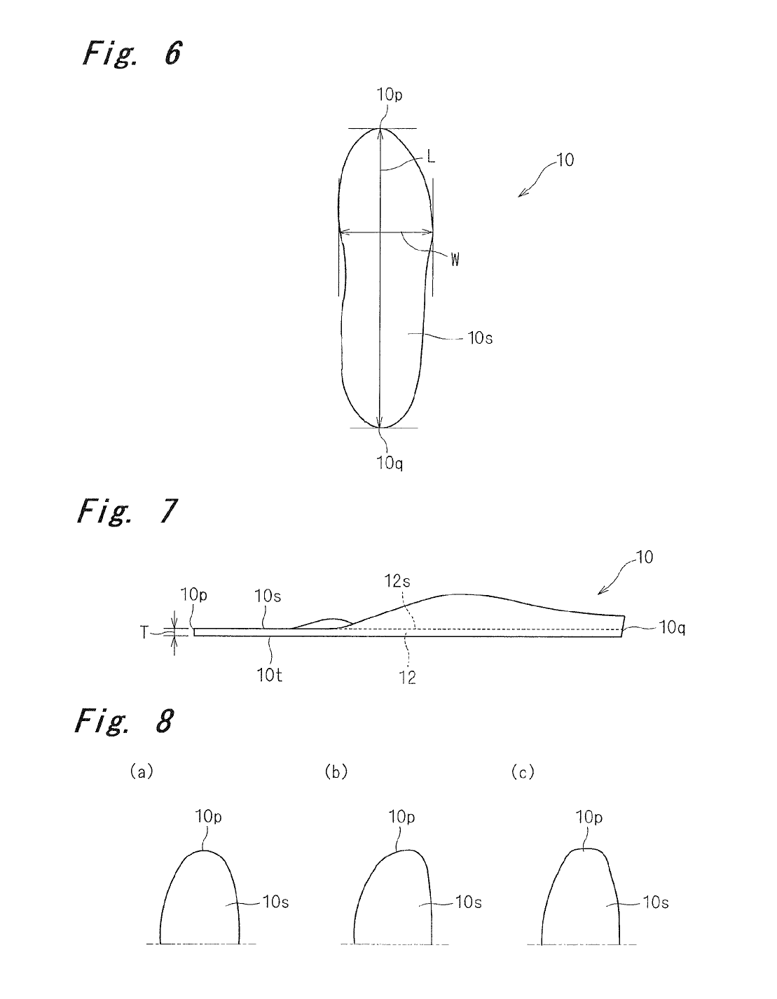

In a state that the screen shown in FIG. 16 is displayed on the terminal 70, when the terminal 70 is operated, basic data of the insole can be inputted. That is, the basic data that can be inputted are: the insole length L and the insole width W shown in the plan view of FIG. 6; the insole thickness T shown in the side view of FIG. 7 (the dimension between the bottom face 12t and the upper face 12s concerning the base part 12 having a fixed thickness); and the type of insole shape concerning the foot tip portion shown in the enlarged main part view of FIG. 7. FIG. 7(a) shows a round type, FIG. 7(b) shows an oblique type, and FIG. 7(c) shows a square type. In FIGS. 6 to 8, numeral 10p indicates a foot-tip-side end and numeral 10q indicates a heel-side end. The basic data of the insole is inputted in accordance with the dimensions and the shape of the inside of the shoe in which the insole is to be placed.

### (b) Peak Height, Peak Position, and Arch Length of Inner Arch

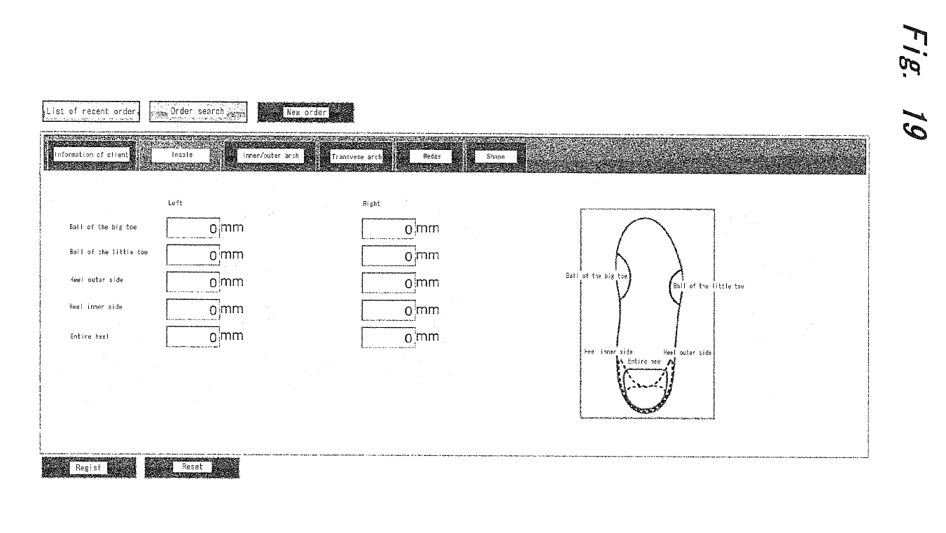

In a state that the screen shown in FIG. 17 is displayed on the terminal 70, when the terminal 70 is operated, design parameters (the peak height, the peak position, and the arch length) concerning the inner arch 10a (see FIG. 2) of the insole 10 can be inputted.

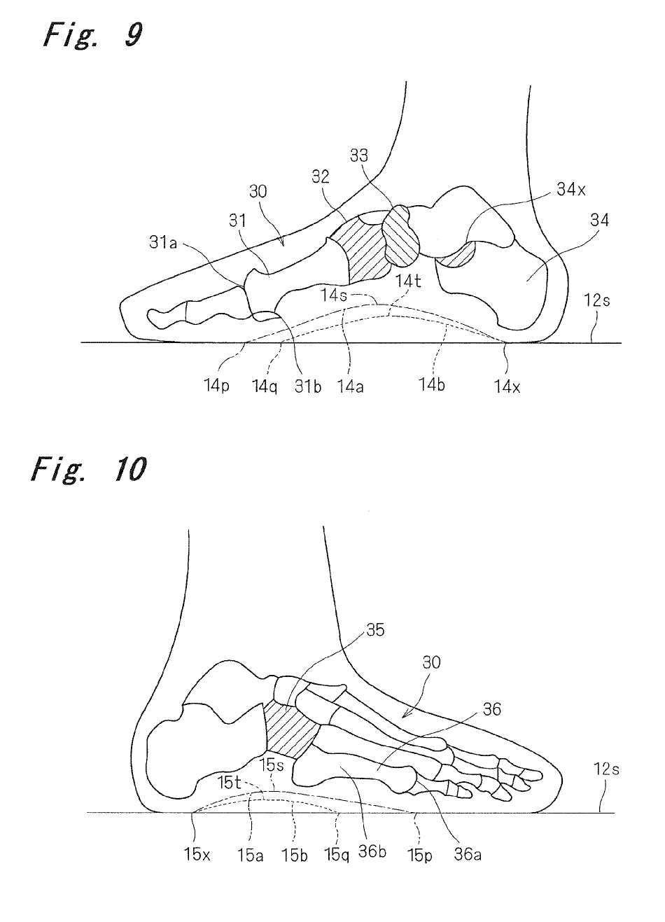

As shown in FIG. 9, the peak heights indicate the heights of the peaks 14s and 14t of the inner arches 14a and 14b and are vertical dimensions measured from a reference plane 12s (the upper face 12s of the base part 12). The peak positions are the positions of the peaks 14s and 14t of the inner arches 14a and 14b. Then, the position of any one of the medial cuneiform bone 32, the navicular bone 33, and the sustentaculum tali 34x of the heel 34 is selected and then, when necessary, the dimension in the foot length direction from the selected position to the peak position is inputted. That is, the peaks 14s and 14t of the inner arches 14a and 14b are arranged immediately under the selected bone or alternatively at a position shifted therefrom in the foot length direction.

As the arch length, the positions of the foot-tip-side ends 14p and 14q of the inner arches 14a and 14b are inputted. That is, the position of the head 31a or the near side 31b of the head of the first metatarsal bone 31 is selected and then, when necessary, the dimensions in the foot length direction from the selected position to the foot-tip-side ends 14p and 14q are inputted. The heel-side end 14x of the inner arches 14a and 14b is determined with reference to the position of the heel 34 and hence input of design parameters is unnecessary. Both ends 14p, 14q; 14x of the inner arches 14a and 14b are located on the reference plane 12s (the upper face 12s of the base part 12).

### (c) Peak Height, Peak Position, and Arch Length of Outer Arch

In a state that the screen shown in FIG. 17 is displayed on the terminal 70, when the terminal 70 is operated, design parameters (the peak height, the peak position, and the arch length) concerning the outer arch 10b (see FIG. 2) of the insole 10 can be inputted.

As shown in FIG. 10, the peak heights indicate the heights of the peaks 75s and 15t of the outer arches 15a and 15b and are vertical dimensions measured from a reference plane 12s (the upper face 12s of the base part 12). The peak positions are the positions of the peaks 15s and 15t of the outer arches 15a and 15b and, when necessary, with adopting as a reference a predetermined position (e.g., the center position) of the cuboid bone 35, the dimension in the foot length direction from the reference position to the peak position is inputted. That is, the peaks 15s and 15t of the outer arches 15a and 15b are arranged immediately under the predetermined position of the cuboid bone 35 or alternatively at a position shifted therefrom in the foot length direction.

As the arch length, the positions of the foot-tip-side ends 15p and 15q of the outer arches 15a and 15b are inputted. That is, the position of the head 36a or the intermediary position 36b of the fifth metatarsal bone 36 is selected and then, when necessary, the dimensions in the foot length direction from the selected position to the foot-tip-side ends 15p and 15q are inputted. The heel-side end 15x of the outer arches 15a and 15b is determined with reference to the position of the heel 34 and hence input of design parameters is unnecessary. Both ends 15p, 15q; 15x of the outer arches 15a and 15b are located on the reference plane 12s (the upper face 12s of the base part 12).

### (d) Peak Height and Peak Position of Transverse Arch

In a state that the screen shown in FIG. 18 is displayed on the terminal 70, when the terminal 70 is operated, design parameters (the peak height and the peak position) concerning the transverse arch 10c (see FIG. 2) of the insole 10 can be inputted.

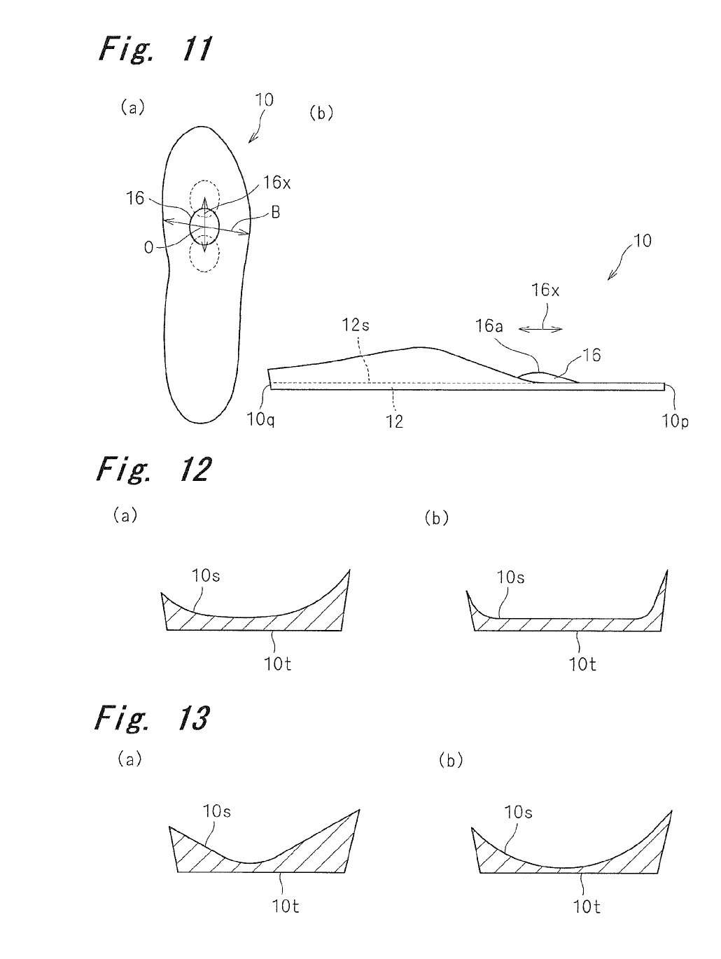

As shown in the plan view of FIG. 11(a) and the side view of FIG. 11(b), the peak height indicates the height of the peak 16a of the transverse arch 16 and is a vertical projection dimension from the reference plane 12s. The peak position is defined with reference to the center point O of the foot width B and, when necessary, a dimension is inputted by which the peak 16a of the transverse arch 16 is to be shifted from the reference position (the center point O) in the foot length direction indicated by an arrow 16x.

Here, the peak position of the transverse arch is fixed in the foot width direction. Since the cross-sectional shape of the transverse arch is determined in advance, the peak length is determined from the peak height. However, a configuration may be employed that the peak position in the foot width direction can be inputted (can be moved). Further, a configuration may be employed that the peak length can be inputted.

### (e) Wedge

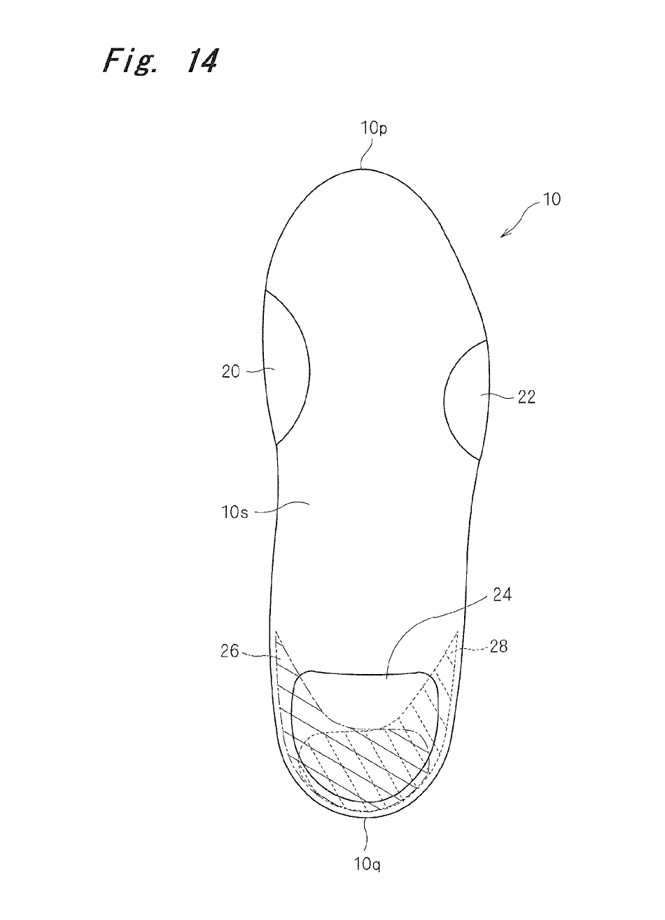

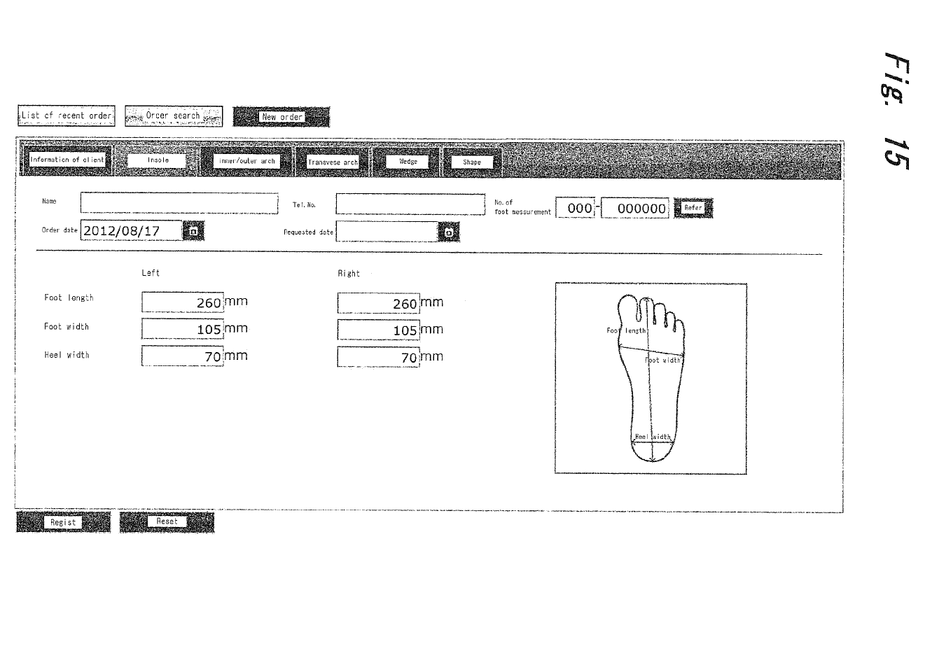

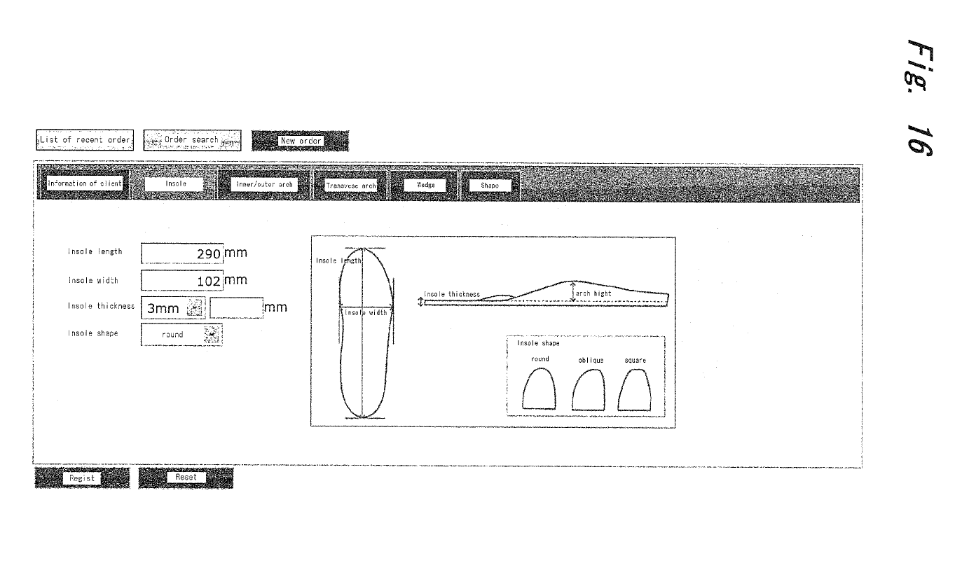

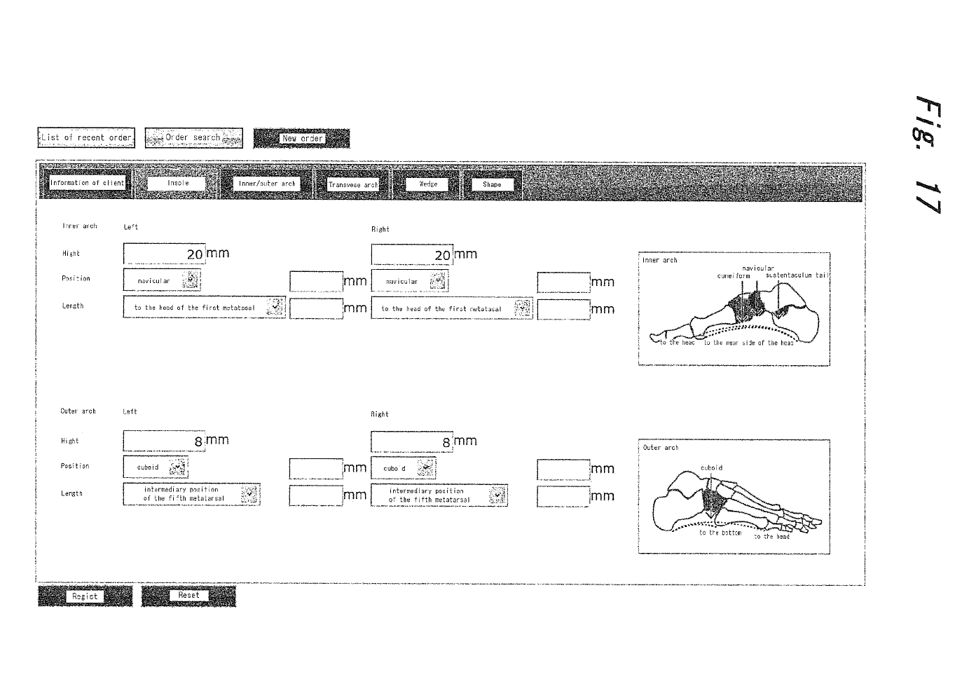

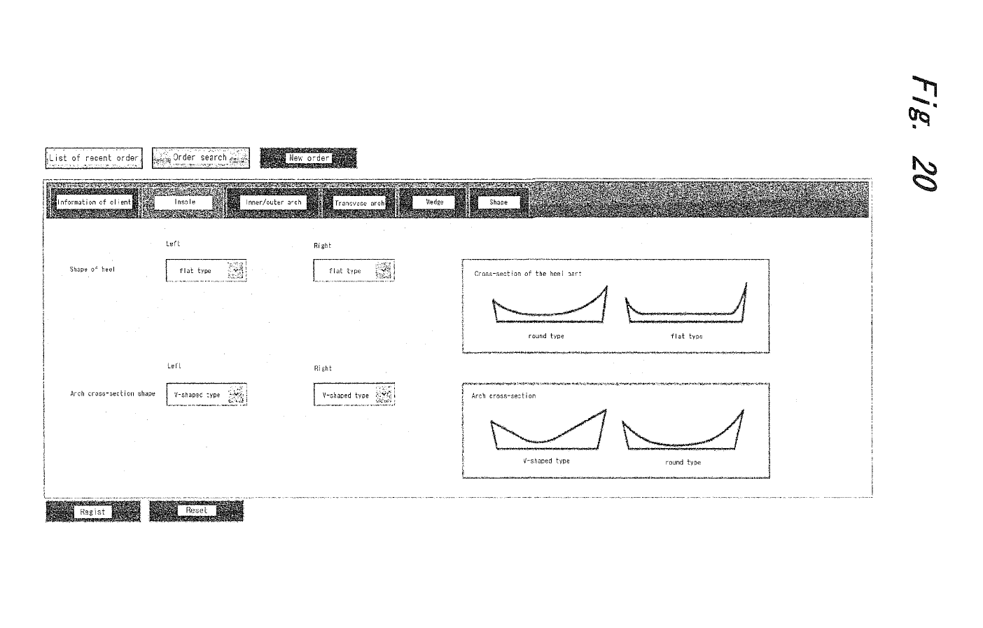

In a state that the screen shown in FIG. 19 is displayed on the terminal 70, when the terminal 70 is operated, the heights of the ball 20 of the big toe, the ball 22 of the little toe, the entire heel 24, the heel inner side 26, and the heel outer side 28 from the reference plane 12s as shown in the explanation diagram of FIG. 14 are inputted as the design parameters. On the basis of these parameters, the inclination of the foot can be adjusted.

### (f) Shape of Heel

In a state that the screen shown in FIG. 20 is displayed on the terminal 70, when the terminal 70 is operated, design parameters concerning the shape of the heel part can be inputted.

The shape of the heel part is selected from the round type shown in FIG. 12 (a) and the flat type shown in FIG. 12 (b). Each of FIGS. 12 (a) and 12 (b) shows a cross section of the heel part 10d of the insole 10 taken along the foot width direction (a direction intersecting with the foot length direction).

### (g) Arch Cross-Sectional Shape

In a state that the screen shown in FIG. 20 is displayed on the terminal 70, when the terminal 70 is operated, design parameters concerning the arch cross-sectional shape can be inputted.

The arch cross-sectional shape is selected from the V-shaped type shown in FIG. 13(a) and the round type shown in FIG. 13 (b). Each of FIGS. 13 (a) and 13 (b) shows a cross section of the middle part in the foot length direction of the insole 10 taken along the foot width direction.

Returning to FIG. 3, from the position of the bone estimated by the bone position estimation unit 56 and the design parameters whose input has been received by the design parameter input unit 54, the data calculation unit 58 calculates data used for forming the stereoscopic shape of the surface 10s of the insole 10. For example, the data calculation unit 58 calculates control data used for controlling the position, the revolving speed, and the like of a cutting tool when a smooth and continuous curved surface shape having the arch shape and the cross-sectional shape defined by the design parameters is to be cut out by an insole machining device. Alternatively, the data calculation unit 58 calculates data serving as the source of control data for the insole machining device, for example, the data of a smooth and continuous curved surface shape having the arch shape and the cross-sectional shape defined by the design parameters. In a case that the insole has a composite structure obtained by joining a plurality of members whose hardness and shapes are different from each other, the data calculated by the design parameter calculation unit 58 may include data of the materials and the dimensions of the members added partly for the purpose of forming the stereoscopic shape of the surface 10s of the insole 10.

The output unit 60 outputs the data calculated by the data calculation unit 58 to the insole machining device directly, to a temporary memory, to a recording medium, to a terminal for design, or to any other terminal.

When the insole design system 50 described above is employed, the shape of the insole can be designed easily and efficiently with taking into consideration the position of the bone of the foot. The design parameters are determined with reference to the position of the bone. Thus, when a design rule is set forth in advance, any person can perform the design similarly so that insoles of fixed quality can be designed and fabricated.

Further, since the design parameters are defined with reference to the position of the bone, the design parameters can be explained in an easy-to-understand manner.

Further, as the fabrication history of the insole, design parameters defined with reference to the position of the bone of the foot are accumulated so that the fabrication history of the insole can be utilized easily and efficiently, for example, in a case that an insole used in another shoe is to be fabricated on the basis of design data of an insole fabricated in the past or, alternatively, in a case that an insole is to be refabricated with observing a change in the shape of the foot or in the motion of the foot at the time of walking caused by the use of the insole. For example, when the arch structure of the foot is to be corrected by using an insole, an insole whose shape is changed in accordance with advancement in the correction can be designed and fabricated easily.

### <Conclusion>

When the insole design system described above is employed, the design parameters can be determined in accordance with a fixed rule and the design parameters can be explained in an easy-to-understand manner.

Here, the present invention is not limited to the above-mentioned embodiments and may be implemented in a state that various kinds of changes are added.

For example, the design parameters and the bone serving as a reference of the design parameters maybe selected suitably and the selection is not limited to the embodiments. For example, input of design parameters concerning the positions in the foot width direction of the inner arch and the outer arch may be received.

Further, in addition to application to an insole equipped in footwear in an attachable and detachable manner (an insole fabricated separately from footwear), the insole design system of the present invention may be applied to an insole constituting a part of footwear (a portion in contact with the sole) (an insole belonging to footwear itself). For example, the insole design system of the present invention may have a configuration that the data calculation unit calculates machining device control data used for cutting out the surface shape of an in-contact-with-the-sole portion of footwear such as a sandal and a wooden clog.

### DESCRIPTION OF REFERENCE NUMERALS

2 Foot
4 Inner side longitudinal arch
6 Outer side longitudinal arch
8 Transverse arch
10 Insole
10a Inner arch
10b Outer arch
10c Transverse arch
10d Heel part
10p Foot tip
10q Heel-side end
10s Surface
12 Base part
12s Upper face (reference plane)
12t Bottom face
14a, 14b Inner arch
14p, 14q Foot-tip-side end (one end)
14s, 14t Peak
14x Heel-side end (other end)
15a, 15b Outer arch
15p, 15q Foot-tip-side end (one end)
15s, 15t Peak
15x Heel-side end (other end)
16 Transverse arch
16a Peak
16x Foot length direction
20 Ball of big toe
22 Ball of little toe
24 Entire heel
26 Heel inner side
28 Heel outer side
30 Skeleton
31 Metatarsal
31a Head of bone
31b Near side of head of bone
32 Medial cuneiform bone
33 Navicular bone
34 Heel
34x Sustentaculum tali
35 Cuboid bone
36 Fifth metatarsal
36a Head of bone
36b Intermediary position
50 Insole design system
52 Foot dimensions input unit
54 Design parameter input unit
56 Bone position estimation unit
58 Data calculation unit
60 Output unit
70 Terminal
80 Communication network

1. An insole design system comprising:
a foot dimensions input unit for receiving input of dimensions of an outer shape of a foot;
a design parameter input unit for receiving input of design parameters concerning a shape of a specific portion of a surface of an insole and determined with reference to a position of a bone of the foot;
a bone position estimation unit for estimating the position of the bone serving as a reference of the design parameters, from the dimensions received by the foot dimensions input unit; and
a data calculation unit for, from the position of the bone estimated by the bone position estimation unit and the design parameters received by the design parameter input unit, calculating data used for forming the shape of the surface of the insole.

2. The insole design system according to claim 1, wherein:
the specific portion includes an inner arch corresponding to an inner side longitudinal arch of the foot;
the design parameters include a peak height, a peak position, and an arch length of the inner arch;
the peak position of the inner arch is determined with reference to any one of a medial cuneiform bone, a navicular bone, and a sustentaculum tali of the calcaneus bone;
in the arch length of the inner arch, one end of the inner arch is determined with reference to a position of the heel and the other end of the inner arch is determined with reference to a position of the first metatarsal bone; and
the bone position estimation unit estimates the positions of the medial cuneiform bone, the navicular bone, the calcaneus bone and the sustentaculum tali thereof, and the first metatarsal bone, from the dimensions received by the foot dimensions input unit.

3. The insole design system according to claim 1, wherein:
the specific portion includes an outer arch corresponding to an outer side longitudinal arch of the foot;
the design parameters include a peak height, a peak position, and an arch length of the outer arch;
the peak position of the outer arch is determined with reference to the position of the cuboid bone;
in the arch length of the outer arch, one end of the outer arch is determined with reference to a position of the calcaneus bone and the other end of the outer arch is determined with reference to a position of the fifth metatarsal bone; and
the bone position estimation unit estimates the positions of the cuboid bone, the calcaneus bone, and the fifth metatarsal bone from the dimensions received by the foot dimensions input unit.
